(19) United States
(12) Patent Application Publication
(10) Pub. No.: US 2007/0192840 A1
(43) Pub. Date: Aug. 16, 2007

(54) Mobile communication terminal

(76) Inventor: Lauri Pesonen, Espoo (FI)

Correspondence Address: PERMAN & GREEN, 425 POST ROAD, FAIRFIELD, CT, 06824, US

(21) Appl. No.: 11/352,401

(22) Filed: Feb. 10, 2006

(51) Int. Cl. H04L 9/32

(52) U.S. Cl. 726/5

(57) ABSTRACT

A mobile communication apparatus comprising a secure element and such a secure element is disclosed. Further a user interface arranged to display a first set of resources and, upon authentication of an approved user identification, to display a second set of resources, wherein said second set of resources comprises at least one resource associated with security sensitive data is disclosed. The user interface is preferably used in an apparatus such as a mobile phone or a personal digital assistant (PDA). The secure element has capability of securely storing the security sensitive data and securely processing this data internally, comprising data related to at least one resource, and a user authentication means, wherein existence of the at least one resource is not revealed outside the secure element unless an approved user identification related to the resource is authenticated by said user authentication means.

### TECHNICAL FIELD

The present invention relates to a secure element and a mobile communication apparatus comprising such a secure element. The invention further relates to a user interface and an apparatus comprising the user interface. In particular, the invention relates to controlling resources such that they are not revealed outside the secure element unless a user identification is authenticated.

### BACKGROUND OF THE INVENTION

Personal mobile devices, such as a mobile phone, may contain security sensitive personal applications and data, such as credit card data. Most of the time the mobile device is in the possession and control of its owner. However, occasionally the mobile device may be given to other people for use, usually for a short period of time. Additionally there may arise a need to give the mobile device to a third party for a longer period of time, e.g. for maintenance. In such cases it would be desirable that the owner of the mobile device can make these personal applications disabled while the mobile device is not in the possession of the owner.

A method an apparatus for secure leveled access control is disclosed in WO 02/33521 A2, which is hereby incorporated by reference. The method and apparatus are arranged to disable functions of processing circuits until an authentication process is successful. The authentication is performed by a key corresponding to the desired function.

### SUMMARY OF THE INVENTION

In view of the above, an objective of the invention is to further reduce the amount of personal information that can be obtained from the mobile device.

According to a first aspect of the present invention, there is provided a secure element with capability of securely storing security sensitive data. The secure element comprises data related to at least one resource, and a user authentication means, wherein existence of the at least one resource is not revealed outside the secure element unless an approved user identification related to the resource is authenticated by the user authentication means. Thereby, applications are not only disabled, they are not revealed outside the secure element, and can thus not be identified, which substantially reduces the risk of information leakage. In short, it is harder to break into something that you are not aware that it exists. In addition to that, there is also information in that you are in the possession of a resource, but with the present invention, this information is not available unless an approved relation exists and is proven between the user and the resource.

The secure element may comprise an operating system for controlling operation of the at least one resource, and reception and authentication of the user identification. Having a secure element having its own operating system further improves security. The sucure element may be a smart card. Examples of smart cards that may be used are Java card with Global Platform functionality, UICC, EMV, PKI, etc. Other examples are SIM cards for telephones, cash and bonus cards, etc.

The at least one resource may comprise an application and the data is adapted for execution of the application. The at least one resource may comprise a plurality of applications, where each application is associated with a separate password. Alternatively, all applications may be associated with a common password. The plurality of applications may be grouped into a plurality of application groups, where each application group is associated with a separate password.

The at least one resource may comprise a data item and the data is adapted for providing the data item to an application. The at least one resource may comprises a plurality of data items, where each data item may be associated with a separate password. Alternatively, all data items may be associated with a common password. The at least one resource may comprise a plurality of data items being grouped into a plurality of data item groups, where each data item group is associated with a separate password.

According to a second aspect of the present invention, there is provided a mobile communication apparatus comprising a secure element according to the first aspect of the invention.

In the mobile communication apparatus, the user identification may be enabled to be entered as a personal identification number.

The at least one resource may comprise an internet banking application, a contact item, an applet, a media file, or a security code item, or any combination thereof.

According to a third aspect of the present invention, there is provided a user interface arranged to display a first set of resources and, upon authentication of an approved user identification, to display a second set of resources, wherein said second set of resources comprises at least one resource associated with security sensitive data. The resources may comprise similar features as those described for the first aspect of the present invention. At least one of said at least one resource associated with security sensitive data may correspond to a resource without association to said security sensitive data in said first set of resources.

According to a fourth aspect of the present invention, there is provided an apparatus comprising a user interface according to the third aspect of the present invention.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the present invention will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a block diagram illustrating a mobile communication apparatus according to an embodiment of the present invention:

FIG. 2 is a block diagram illustrating a secure element according to an embodiment of the present invention;

FIGS. 3a and 3b show an apparatus with a user interface according to an embodiment of the present invention; and

FIGS. 4a and 4b show an apparatus with a user interface according to an embodiment of the present invention.

### DETAILED DESCRIPTION OF PREFERRED EMBODIMENTS

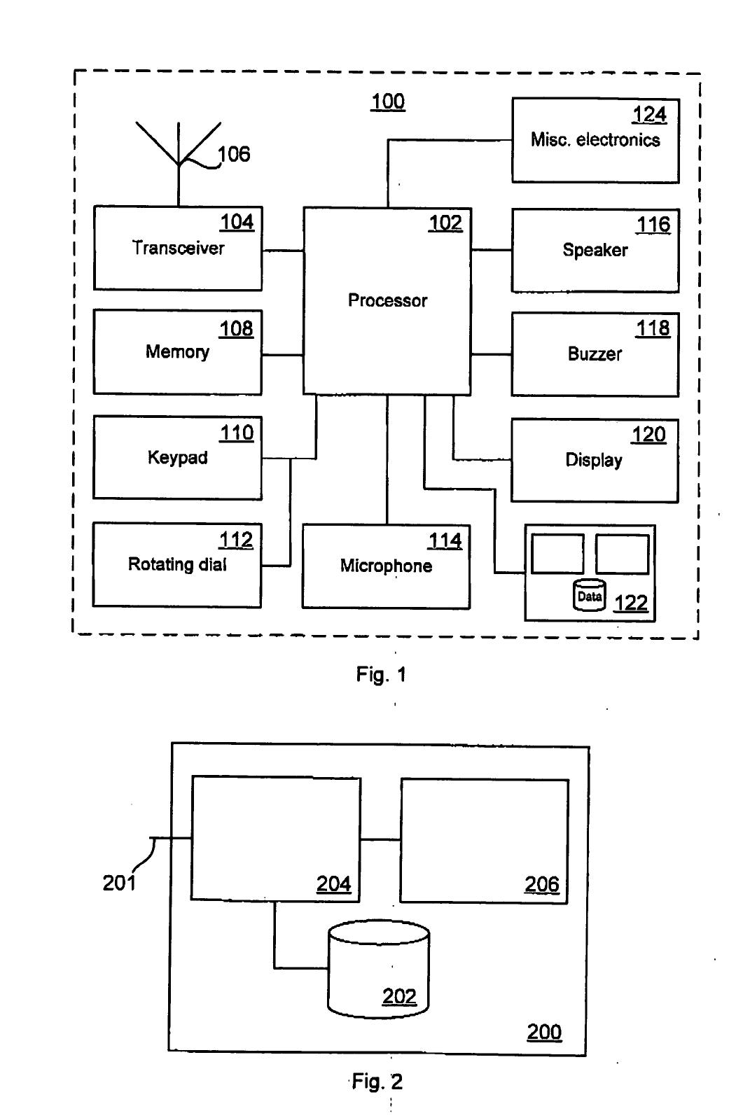

FIG. 1 is a block diagram schematically showing a mobile communication apparatus 100 according to an embodiment of the present invention. The mobile communication apparatus 100 comprises a processor 102 which is arranged to control functions of the mobile communication apparatus 100. In FIG. 1, the connections between elements 104, 108, 110, 112, 114, 116, 118, 120, 124 and the processor 102 depicts the control of the elements, as well as signal transfer and information exchange. However, the elements 104, 108, 110, 112, 114, 116, 118, 120, 124 can have any interconnection for signals or information transfer to any of the other elements 104, 108, 110, 112, 114, 116, 118, 120, 124, which is not shown in FIG. 1 for clarity reasons. The mobile communication apparatus 100 further comprises a transceiver 104 connected to the processor 102 which is arranged to receive and transmit radio signals through an antenna 106. The mobile communication apparatus can further comprise a memory 108, a keypad 110, a rotating dial 112, a microphone 114, a speaker 116, a buzzer 118, and a display 120. Further miscellaneous electronics 124, such as means for infrared data association (not shown), can also be comprised.

The mobile communication apparatus 100 further comprises a secure element 122 having capability of securely storing security sensitive data and processing internal transactions with the data, e.g. payment transactions, key generation, etc. This capability implies that certain data stored in the secure element 122 is only accessible by the processor 102 upon proven access to the data. Further, some data stored in the secure element 122 is only allowed to be processed inside the secure element 122. Examples of this is the access check to data that is to be provided to the processor 102, or generation of keys. The secure element can be a smart card, e.g. a Java, UICC, EMV, PKI, or SIM card, or a protected circuit in the mobile communication apparatus 100, e.g. a microprocessor with internal read-only-memory and a protected static random access memory, or a protected part of the processor 102.

FIG. 2 is a block diagram illustrating a secure element 200 according to an embodiment of the present invention. The secure element 200 has a connection 201 for external communication, through which it communicates in a controlled way, as will be further described below. The secure element 200 further comprises data 202 which it stores securely. The data 202 is related to one or more resources. A resource can be an application, e.g. an internet banking application or an applet, or a data item, e.g. a media file, a contact item, a message or a security code. The resources can be a mix of applications and data items. A user authentication means 204 is arranged to check identity and authenticy of a user and will not reveal any of the resources outside the secure element 200. The autheticy can be checked for example by means of a password, biometric data, or an authentication key. The resources can be grouped to be available by joint authentication, either for each group of resources or for all resources. The resources can also be available by separate authentication for each resource. The operation of the secure element 200 can be controlled by an operating system 206, which controls operation of the resources, and reception and authentication of the user identification. By letting the secure element having its own operating system, manipulation of the secure element is strongly obstructed.

A typical deployment scenario can be such that one resource is a smart card application, which contains data and additional functions to process this data, either solely internally, or internally and externally. Note that there can be more than one resource, e.g. application or function. Authentication schemes according to the invention either hide these resources or makes them visible. When hidden, the resources cannot be accessed in any way. Even when the resources are in a visible state, each resource may still implement additional authentication mechanisms, which are not a part of the authentication for hiding and revealing of resources.

Returning to FIG. 1, the mobile communication apparatus 100 normally comprises a user interface which is provided by means of a combination of any of the keypad 110, rotating dial 112, microphone 114, speaker 116, buzzer 118, and the display 120 to interact with a user. By these means, resources such as functions, applications, data, etc. is made available to a user. Resources of the mobile communication apparatus 100 in general are normally made available to a user by e.g. a menu shown by the display 120 or any graphical user interface showing e.g. icons or other symbols on the display 120 associated with the resources.

For the resources of the secure element, which are to be revealed only after proper authentication of the user, it is preferred that the view that the user interface presents to the user is not changed for other resources, which are not part of the protected resources of the secure element or other resources of the secure element that has been made available by proper authentication. This applies for example to short cut keys to applications, speed dialing, menu items, etc. For lists of resources, the unavailable resources are simply not present in the lists.

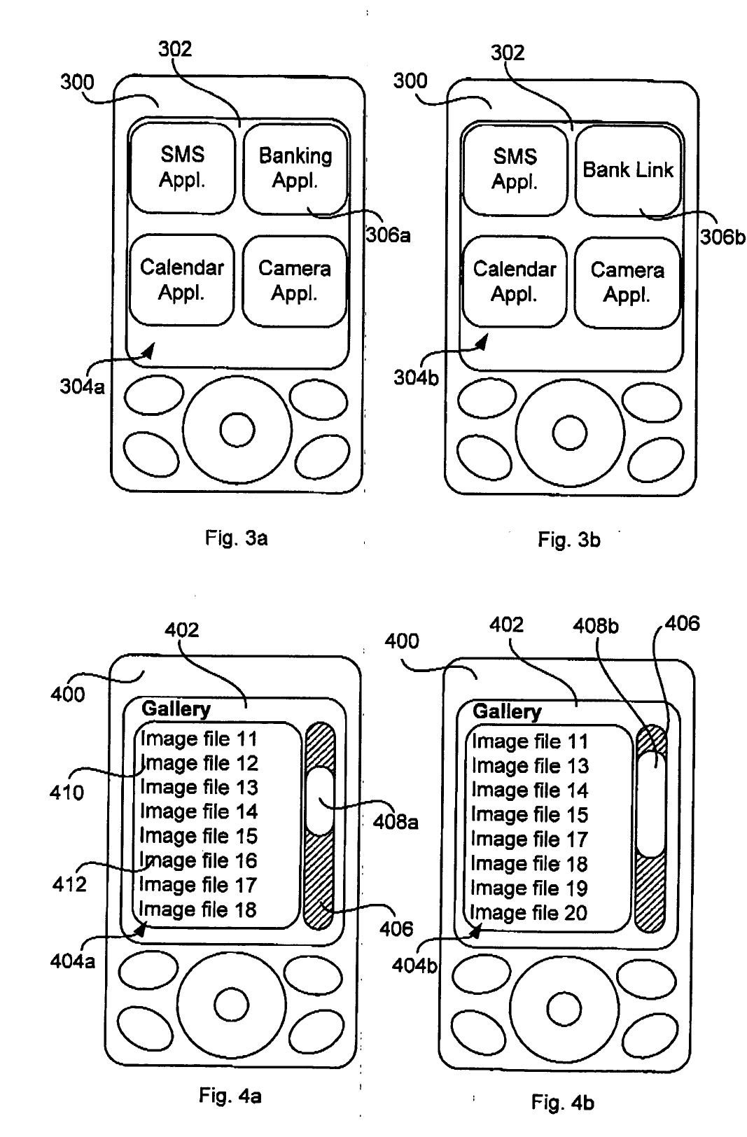

An apparatus 300, 400 provided with such a user interface is preferably provided with a display 302, 402 that is capable of displaying a plurality of items 304a, 304b, or the apparatus is able to scroll between a plurality of items 404a, 404b for viewing on the display, as is illustrated by FIGS. 3 and 4. As described above, this is particularly applicable to a mobile communication apparatus, such as a, mobile telephone, a smart phone, a personal digital assistant, etc., and the ability to protect resources is increasingly important since these types of apparatuses more and more hold security sensitive information.

For graphical user interfaces using e.g. icons, the icons of the unavailable resources are not shown, and the other icons can either remain in their original positions. Thus, as Illustrated by FIGS. 3a and 3b, a user interface has two or more views, where only menu or graphical user interface items 304b, e.g. icons, related to resources that do not comprise security sensitive data, i.e. are not protected by approved user identification, are shown in one view, as illustrated in FIG. 3b, and in the other view or views, items 306a related to protected resources are shown, as illustrated in FIG. 3a. The icons of the unavailable resources can be substituted by icons 306b associated with corresponding resources to the unavailable resources, wherein the corresponding resources can comprise a more general function or application which is not associated to security sensitive data. In the example of FIGS. 3a and 3b, an internet banking application 306a is substituted to a general internet link 306b, e.g. to the official home page of the bank or to a default starting page of an internet browser of the mobile communication apparatus.

Alternatively, as illustrated in FIGS. 4a and 4b, the items 404a can be rearranged to provide a new view comprising only items 404b related to the available resources. In the example of FIGS. 4a and 4b, items 404a comprising a list of image files, the view here being illustrated with a scroll bar 406 with a position and range indicator 408a and the image files 11 to 18 being present on the display 402. In the present example, two items 410, 412 of the plurality of items 404a are related resources of the secure element and being part of the security sensitive data, and in FIG. 4b, a view where no approved user identification is authenticated for these resources is provided on the display 402. Here, the items 410, 412 related to restricted resources, that were present in the view illustrated in FIG. 4a, are no longer displayed in the list of items 404b of FIG. 4b. As it is beneficial to not only hide the items 410, 412, but also any indication that any item is hidden, other parts of the user interface, e.g. the position and range indicator 408a of the scroll bar 406, can be adapted to the new view of items 404b.

As demonstrated by the examples, illustrated by FIGS. 3 and 4, and discussed above, the former alternative is especially applicable to a menu or view of icons related to applications where there is a benefit in that a “work area” of the user interface is not changed. The latter alternative is especially applicable when the resources comprises data items, e.g. personal images, contact items, etc. where no items are corresponding to the unavailable items, and there is a benefit in not showing that an item is hidden. However, the invention is neither limited to only using substitution for icon solutions and pure hiding for list solutions, nor limited to these two exemplary types of graphical user interface. The invention can be used with any combination of substituting, hiding, rearranging, etc. in the user interface with any type of user interface related to resources that need to be restricted, and in combination with non-restricted resources being presented normally by the user interface.

An issuer of the secure element, which can be considered as a trusted party, can be in possession of cryptographic keys enabling certain management operations of the secure element. Thereby, management, such as updating, unlocking the secure element, etc. can be provided to the secure element by the trusted party. This can then be performed by an issuer key, which is one or more keys stored in the secure element and controlled by the issuer. Thus, in addition to the authentication, that can be based on a password or cryptographic key provided by a user or another authentication element, there can be provided a further level of authentication based on a password or key provided by the issuer of the secure element.

The authentication can be based on a password, with which user can set the applications of the secure element to be invisible, and by re-entering this password the applications become visible again on the user interface. Switching between visible and invisible stages does not impact the actual applications in any way, and no modifications would be needed to these applications. In order to protect against password attacks a maximum number of password attempts is defined and this value may be configurable. Here, the issuer can have the capacity to switch the invisible stage back to visible stage and to reset the password to some initial default value, e.g. when the password has been locked after too many incorrect attempts. Both these actions require the issuer key(s) to be used to authenticate securely between the secure element and the issuer.

The described invention can be deployed to a smart card chip with smart card operating system, such as Java smart card with Global Platform, or to similar security hardware devices. The following description focuses on Global Platform Java smart card, but as stated above, the solution is of general nature and thus can be applied for other smart card implementations and to other security hardware devices too.

One implementation scenario of the invention will now be described, where the resources are described as applications and the authentication to be performed with a password for the sake of clarity. However, what is her described is also applicable to other resources such as data items, and the authentication can be performed in any of the above described manners.

In a normal stage of the secure element, in this case Java smart card with Global Platform functionality, all applications are visible to the external world and usable as defined for each application. It may be that specific applications in the secure element are associated with application specific password, such as personal identification number (PIN), while some other applications may be freely usable without any user authentication. This kind of visibility of the specific applications potentially gives unnecessary information to third parties, e.g. to others than the owner, having access to the mobile device. This is solved by an additional password concept to protect the secure element access by making these specific applications invisible to the external world, i.e. outside the secure element and in particular through the user interface.

The operating system of the secure element implements a visibility password. There can be a pre-defined initial default value for the visibility password, e.g. “0000”. The visibility password is managed by the user and thus can be changed by the user upon proper authentication.

The operating system can have the following stages in respect to the application visibility and the visibility password:

OK_Visible; The applications are visible and can be accessed and used as in the normal stage. The visibility password is defined, either by the initial value or another value defined by the user, and unlocked

OK_Invisible; The applications are invisible and cannot be accessed or used. The visibility password is defined, either by the initial value or another value defined by the user, and unlocked

Locked_Invisible; The applications are invisible and cannot be accessed or used. The visibility password is locked and cannot be used

The operating system can implement the following additional operations:

Set_Visibility_Password; The Visibility Password can be set to a new value, for which action the correct current visibility password has to be provided to the operating system. Preferably, this command can be executed only in the OK_Visible stage

Make_Invisible; This operation makes the applications invisible and sets the operating system stage to OK_Invisible. The correct visibility password has to be provided to the operating system as part of this operation. Preferably, this operating can be executed only in the OK_Visible stage

Make_Visible; This operation makes the applications visible and sets the operation system stage to OK_Visible. The correct visibility password has to be provided to the operating system as part of this operation. Preferably, this operation can be executed only in the OK_Invisible stage

Request_OS_stage; This operation returns the information about the operating system stage

Reset_Visible; If the visibility password is locked, the operating system stage will be set automatically to Locked_Invisible. Only the issuer can reset the visibility password back to initial default value and set the operating system stage to OK_Visible with this operation. The operation comprises a mutual authentication with the secure element Issuer Security Domain (ISD) key. The issuer has the ISD Master Keys, from which the secure element specific ISD keys are derived by using a unique serial number, or any other identifier, of the secure element as the diversification element. The unique serial number is publicly readable even in the Locked_Invisible and OK_Invisible stages. This command can also be used in the other two operating system stages, i.e. OK_Visible and OK_Invisible.

The operating system stage is set to Locked_Invisible if the number of incorrect visibility password attempts exceeds a maximum number of allowed attempts.

Java is a trademark or registered trademark of Sun Microsystems, Inc. in the United States and other countries.

The invention has mainly been described above with reference to a few embodiments. However, as is readily appreciated by a person skilled in the art, other embodiments than the ones disclosed above are equally possible within the scope of the invention, as defined by the appended patent claims.

1. A secure element with capability of securely storing security sensitive data, comprising
data related to at least one resource; and
a user authentication means, wherein existence of said at least one resource is not revealed outside said secure element unless an approved user identification related to said resource is authenticated by said user authentication means.

2. The secure element according to claim 1, comprising an operating system for controlling operation of said at least one resource, and reception and authentication of said user identification.

3. The secure element according to claim 1, wherein said at least one resource comprises an application and said data is adapted for execution of said application.

4. The secure element according to claim 1, wherein said at least one resource comprises a plurality of applications, each application being associated with a separate approved user identification.

5. The secure element according to claim 1, wherein said at least one resource comprises a plurality of applications, all applications being associated with a common approved user identification.

6. The secure element according to claim 1, wherein said at least one resource comprises a plurality of applications being grouped into a plurality of application groups, each application group being associated with a separate approved user identification.

7. The secure element according to claim 1, wherein said at least one resource comprises a data item and said data is adapted for providing said data item to an application.

8. The secure element according to claim 1, wherein said at least one resource comprises a plurality of data items, each data item being associated with a separate approved user identification.

9. The secure element according to claim 1, wherein said at least one resource comprises a plurality of data items, all data items being associated with a common approved user identification.

10. The secure element according to claim 1, wherein said at least one resource comprises a plurality of data items being grouped into a plurality of data item groups, each data item group being associated with a separate approved user identification.

11. The secure element according to claim 1, constituting a smart card.

12. A mobile communication apparatus comprising a secure element with capability of securely storing security sensitive data, comprising data related to at least one resource, and a user authentication means, wherein existence of said at least one resource is not revealed outside said secure element unless an approved user identification related to said resource is authenticated by said user authentication means.

13. The mobile communication apparatus according to claim 12, wherein said at least one resource comprises an application and said data is adapted for execution of said application.

14. The mobile communication apparatus according to claim 1, wherein said at least one resource comprises a data item and said data is adapted for providing said data item to an application.

15. The mobile communication apparatus according to claim 12, wherein said user identification is enabled to be entered as a personal identification number.

16. The mobile communication apparatus according to claim 12, wherein said at least one resource comprises an internet banking application, a contact item, an applet, a media file, or a security code item, or any combination thereof.

17. A user interface arranged to display a first set of resources and, upon authentication of an approved user identification, to display a second set of resources, wherein said second set of resources comprises at least one resource associated with security sensitive data.

18. The user interface according to claim 17, wherein at least one of said at least one resource associated with security sensitive data corresponds to a resource without association to said security sensitive data in said first set of resources.

19. The user interface according to claim 17, wherein said at least one resource comprises a plurality of applications, each application being associated with a separate approved user identification.

20. The user interface according to claim 17, wherein said at least one resource comprises a plurality of applications, all applications being associated with a common approved user identification.

21. The user interface according to claim 17, wherein said at least one resource comprises a plurality of applications being grouped into a plurality of application groups, each application group being associated with a separate approved user identification.

22. The user interface according to claim 17, wherein said at least one resource comprises a data item and said data is adapted for providing said data item to an application.

23. The user interface according to claim 17, wherein said at least one resource comprises a plurality of data items, each data item being associated with a separate approved user identification.

24. The user interface according to claim 17, wherein said at least one resource comprises a plurality of data items, all data items being associated with a common approved user identification.

25. The user interface according to claim 17, wherein said at least one resource comprises a plurality of data items being grouped into a plurality of data item groups, each data item group being associated with a separate approved user identification.

26. An apparatus comprising a user interface arranged to display a first set of resources and, upon authentication of an approved user identification, to display a second set of resources, wherein said second set of resources comprises at least one resource associated with security sensitive data.

27. The apparatus according to claim 26, wherein at least one of said at least one resource associated with security sensitive data is substituted with a corresponding resource without association to said security sensitive data in said first set of resources.

28. The apparatus according to claim 26, wherein said at least one resource comprises a plurality of applications, each application being associated with a separate approved user identification.

29. The apparatus according to claim 26, wherein said at least one resource comprises a plurality of applications, all applications being associated with a common approved user identification.

30. The apparatus according to claim 26, wherein said at least one resource comprises a plurality of applications being grouped into a plurality of application groups, each application group being associated with a separate approved user identification.

31. The apparatus according to claim 26, wherein said at least one resource comprises a data item and said data is adapted for providing said data item to an application.

32. The apparatus according to claim 26, wherein said at least one resource comprises a plurality of data items, each data item being associated with a separate approved user identification.

33. The apparatus according to claim 26, wherein said at least one resource comprises a plurality of data items, all data items being associated with a common approved user identification.

34. The apparatus according to claim 26, wherein said at least one resource comprises a plurality of data items being grouped into a plurality of data items groups, each data item group being associated with a separate approved user identification.

35. The apparatus according to claim 26, constituting a mobile telephone or a personal digital assistant.
